(19) United States
(12) Patent Application Publication
(10) Pub. No.: US 2007/0101030 A1
(43) Pub. Date: May 3, 2007

(54) Bus system for integrated circuit

(75) Inventor: Harald Fischer, Braubach/Rhein (DE)

Correspondence Address: MCGRATH, GEISSLER, OLDS & RICHARDSON, PLLC, P.O. BOX 1364, FAIRFAX, VA, 22038-1364, US

(73) Assignee: Atmel Germany GmbH

(21) Appl. No.: 11/586,711

(22) Filed: Oct. 26, 2006

(30) Foreign Application Priority Data
Oct. 27, 2005 (DE) 10 2005 051 411.1

(51) Int. Cl. G06F 13/00

(52) U.S. Cl. 710/107

(57) ABSTRACT

A bus system is disclosed for establishing signal connections to a plurality of functional units standing in operative connection to the integrated circuit, which are designed to generate and/or process digital and/or analog signals. The system includes a digital bus and an analog bus. The inclusion of an analog bus in an integrated circuit in addition to a digital bus has the result of complete modularity of the integrated circuit with regard to the use of a wide variety of functional units, so that the integrated circuit can be used in practically any way desired. In addition, because of the presence of an additional analog bus, the analog-to-digital and digital-to-analog converters normally present according to the prior art may be omitted, resulting in a corresponding saving of space and power.

This nonprovisional application claims priority under 35 U.S.C. § 119(a) on German Patent Application No. DE 102005051411, which was filed in Germany on Oct. 27, 2005, and which is herein incorporated by reference.

### BACKGROUND OF THE INVENTION

1. Field of the Invention

The present invention relates to a bus system internal to an IC for establishing signal connections to a plurality of functional units standing in operative connection to the integrated circuit (IC), which are designed to generate and/or process digital and/or analog signals.

In addition, the present invention relates to an integrated circuit for connecting a number of functional units, and a circuit arrangement.

2. Description of the Background Art

In prior art bus systems internal to an IC for connecting a plurality of functional units standing in operative connection to the IC, for example sensors for supplying analog measurement signals, field bus drivers or the like, purely digital busses are often provided in conjunction with suitable analog-to-digital converters and digital-to-analog converters. These convert, in particular, analog signals originating from the functional units into digital signals, which then are transmitted through the bus system internal to the IC to other functional units or to data processing units within the IC. In this context, a reconversion into analog signals takes place if necessary before the converted analog signals are delivered to the functional units.

In such prior art bus systems or circuit arrangements having an IC and functional units, it must be considered a particular disadvantage that the multivalent provision of analog-to-digital or digital-to-analog converters results in a large space requirement for a suitably equipped integrated circuit. Moreover, this is associated with corresponding cost disadvantages in manufacturing. In addition, the presence of the aforementioned converters disadvantageously results in increased power consumption by the IC.

### SUMMARY OF THE INVENTION

It is therefore an object of the present invention to provide a bus system internal to an integrated circuit, an integrated circuit for connecting a number of functional units, and a circuit arrangement having an integrated circuit and a number of connected functional units, in which the aforementioned disadvantages are avoided. In addition, the devices to be created should be modular in design and thus usable as desired.

The object is attained in a bus system of the aforementioned type in that the system has both a digital bus and an analog bus.

In an integrated circuit of the aforementioned type, the object is attained in that said circuit contains an inventive bus system.

Finally, the object is attained for a circuit arrangement in that the arrangement has an inventive integrated circuit and also a number of functional units connected to the integrated circuit, wherein the functional units are designed to generate and/or to process digital and/or analog signals.

The inclusion of an analog bus in an integrated circuit in addition to a digital bus results in complete modularity of the integrated circuit with regard to the use of a wide variety of functional units, so that the integrated circuit can be used in practically any way desired. As part of the inventive modularity concept, an inventive integrated circuit preferably has a standardized, internal bus sequence with timing, interrupt controlling, and wake-up conditions, including controlled power management.

Because of the presence of an additional analog bus, the analog-to-digital and digital-to-analog converters normally present according to the prior art may be omitted, resulting in a corresponding saving of space and power.

In a further embodiment of the bus system, provision is made for the system to have a central master control unit for the digital bus and for the analog bus, which control unit is designed for time-controlled delivery of digital signals and/or analog signals to the appropriate functional units. In this way, an application-specific design of the overall bus system and/or of an integrated circuit built thereon can be achieved through an appropriate design or adaptation of the central control unit alone, thus ensuring the desired complete modularity of the arrangement.

As part of another embodiment of the inventive bus system, provision is made for the bus system to have a plurality of interface functional modules, each of which is designed to connect at least one functional unit to the bus system. As part of the standardization efforts underlying the invention, the aforementioned interface functional modules can be based on a widely used standard. The interface functional modules can also be designed as IP modules (IP—IndustryPack®). IP modules are standardized, general-purpose modules with which a wealth of input/output, control, interface, analog, and digital functions can be implemented, which are known to those skilled in the art (cf. “IP Modules Draft Standard,” VITA 4-1995, Draft 1.0.b.0, dated Apr. 7, 1995).

In order to function entirely without analog-to-digital or digital-to-analog converters in accordance with the invention, provision is made according to a further embodiment of the inventive bus system that the interface functional modules are designed to route digital signals received from the applicable functional units on the digital bus, and to route analog signals received from the applicable functional units on the analog bus.

According to another embodiment of the inventive bus system, the master control unit stands in connection with at least one memory unit and/or data processing unit. In this way, it is possible, in particular, to implement the above-mentioned standard bus sequence, including timing, etc., by the data processing unit. Moreover, on account of the aforementioned connection, it is possible to realize the master control unit as a program code mechanism during the course of execution by the data processing unit of an appropriate program code, wherein the appropriate program code can be contained in the memory unit.

In a further embodiment of the inventive bus system, provision can be made for the master control unit to be designed as a state machine. Such a state machine is distinguished by rigidly predefined assignments between input and output signals which are transmitted over the inventive bus system between the master control unit and the interface functional modules (and vice versa), wherein certain states or state changes bring about corresponding predetermined actions (signal transmissions). In this regard, as part of another embodiment of the inventive bus system, the master control unit can be set up in the software for signal transmission on the digital and analog busses. In particular, the state machine can also be designed in the form of software, for example in the form of an event-controlled state machine or as a virtual state machine, for example using the aforementioned data processing unit. Alternatively, the state machine, in particular, can be implemented as a digital switch with the aid of PLCs, logic gates, flip-flops, or relays.

In another embodiment of the inventive bus system, provision is made for the master control unit, which is to say especially the state machine, to be set up for signal transmission on the digital bus and on the analog bus according to predefined assignments, in particular in the form of ROM tables. This corresponds to an application-specific quasi-hard wiring of inputs and outputs in the bus system of the inventive IC for the purpose of a certain type of signal forwarding, wherein the desired modularity or multipurpose usability of the integrated circuit is ensured in particular on account of the fundamental changeability of the ROM tables.

In order to provide the option of comprehensively testing the IC or its individual components, and also the software, to users or manufacturers of such an integrated circuit with application-specific setup, the bus system can have an additional interface for connecting a test apparatus designed for testing at least one of the functional units, interface functional modules, or signal transmission configuration of the master control unit. In the context of the present invention, a “signal transmission configuration” should be understood to mean the application-specific assignment of inputs and outputs for the purpose of signal transmission as explained in detail above.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a circuit arrangement with IC-internal bus system and a plurality of functional units, according to an embodiment of the present invention; and

FIG. 2 is a functional block diagram of the internal bus system of the invention.

### DETAILED DESCRIPTION

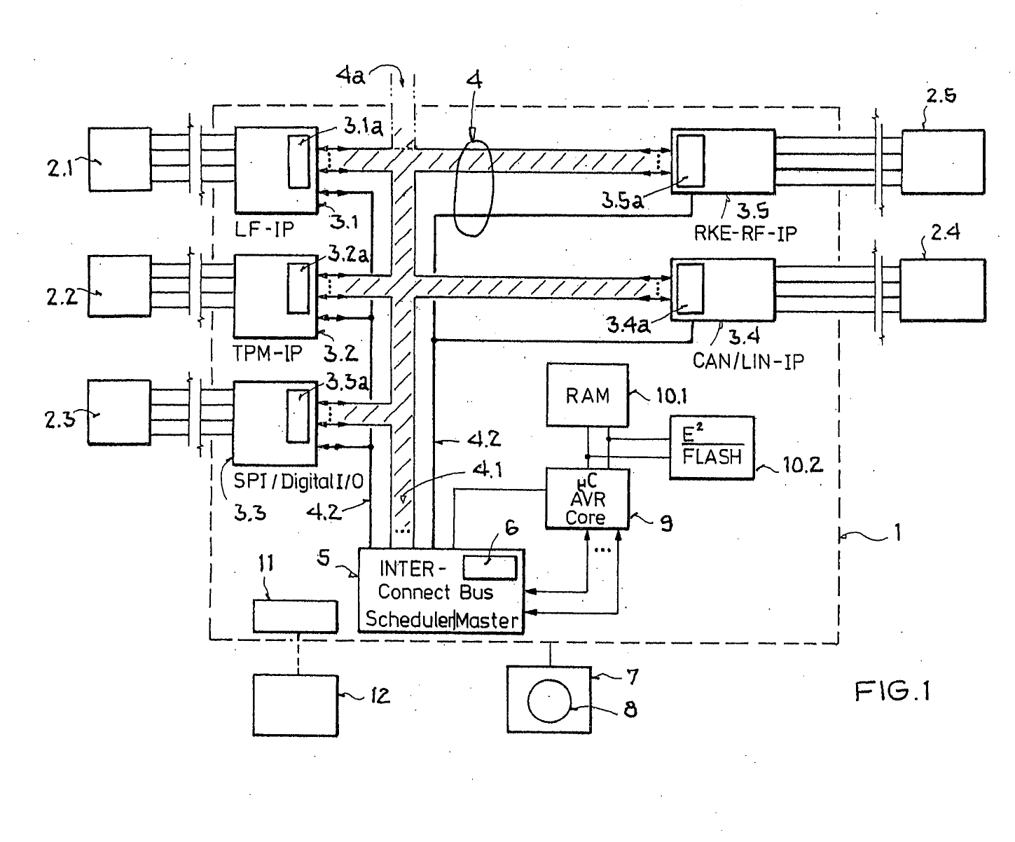

FIG. 1 uses a box shown in dashed lines to show an integrated circuit (IC) 1, with which a plurality of functional units 2.1-2.5 stand in operative connection. The functional units 2.1-2.5 may be, for example, functional units for tire pressure measurement (TPM), for remote keyless entry for a motor vehicle (RKE), for driving a field bus (for example a CAN bus), or the like. The IC 1 is thus especially suitable for use in RKE/TMP/PEG systems (PEG=Passive Entry Go).

As shown in FIG. 1, the IC 1 has a number of interface functional modules 3.1-3.5, which are connected to one another through a bus system 4. Each of the interface functional modules 3.1-3.5 additionally stands in operative connection with an assigned functional unit 2.1-2.5, for example a sensor. As is shown in an area 4a of the bus system 4, the bus system 4 can in principal be expanded by additional interface functional modules or appropriately assigned functional units (indicated by dashed lines).

The bus system 4 has a digital bus 4.1 and an analog bus 4.2. The interface functional modules 3.1-3.5 are preferably designed as IP modules (IP—IndustryPack®), wherein the corresponding specifications are common knowledge to those skilled in the art. Each of the interface functional modules 3.1-3.5 has a control unit 3.1a-3.5a, which is designed as a completely independent circuit component within the IC 1. The control units 3.1a-3.5a function as analog/digital bus schedulers for transmitting digital signals DS or analog signals AS from the respective functional units 2.1-2.5 to the bus system 4 and for transmitting the corresponding signals from the bus system 4 to the applicable functional unit 2.1-2.5, which is indicated in FIG. 1 by means of double arrows AS, DS.

In the bus system 4, the IC 1 shown additionally has a central master control unit 5, so that the latter stands in operative signal connection with both the digital bus 4.1 and the analog bus 4.2. In the case of the example embodiment shown, the master control unit 5 contains assignment specifications for signal transmission on the digital bus 4.1 and analog bus 4.2 in the form of a ROM table 6. In order to implement the ROM table 6, in particular, the IC 1 stands in operative connection—as shown—with a suitable input device 7, which is designed to read in a data carrier medium 8, in particular containing an image of the ROM table 6, which is common knowledge to those skilled in the art. In addition, the master control unit 5 is connected to a data processing unit 9, for example a microprocessor, and also through it to memory units in the form of a RAM memory 10.1 and an EEPROM/FLASH memory 10.2. As an alternative to the solution described above, the ROM table can also be contained in the read only memory (ROM) 10.2 designed especially as an EEPROM/FLASH memory.

The IC 1 from FIG. 1 also has an interface 11 for connecting to a test apparatus 12, wherein the interface 11 can be designed in such a manner that the test apparatus 12 is either connected through a so-called air interface or through the connection pins (not shown) of the IC 1, which is symbolized in FIG. 1 by a dashed line.

The circuit arrangement described above provides, in a novel way, a single bus system 4 for analog and digital signals AS and DS with a consistent interface between all interface functional modules 3.1-3.5 with high redundancy and expansion capability, so that the IC 1 is fully modular. Due to the provision of a central control unit 5 for the digital bus 4.1 and analog bus 4.2, a standardized internal bus sequence can be realized, including timing, interrupt controlling, and wake-up conditions, including controlled power management. In this connection, the central master control unit 5 assumes a routing function for the digital and analog signals DS and AS arriving at or present in the bus system 4. Accordingly, the master control unit 5 passes the digital signals DS through to their destination addresses, i.e. a specific functional unit 2.1-2.5 or the associated interface functional modules 3.1-3.5, in accordance with their addressing. The master control unit 5 appropriately determines what if any analog signal AS is present on the analog bus 4.2 and outputs it again correspondingly (in a time-controlled manner) over the analog bus 4.2 for use by one of the functional units 2.1-2.5 or the associated interface functional modules 3.1-3.5. In this sense the master control unit 5 functions as an analog-to-analog converter (driver).

In general, sequence control for signal transmission on the bus system 4 is performed by the master control unit 5 according to predefined assignment specifications, which in the example embodiment shown are stored in the master control unit 5 in the form of a ROM table 6. Using these assignments, the master control unit 5 “knows” which signals (digital signals DS and analog signals AS) are to be routed when and where on the bus system 4. For example, when the functional unit 2.2 (TPM-IP) responsible for an analog tire pressure measurement transmits an analog tire pressure measurement over the analog bus 4.2 as an analog signal AS through the interface module 3.2 assigned to it, the master control unit 5 knows, from the ROM table 6, that the corresponding measurement is needed by, for example, the functional unit 2.4. Accordingly, the master control unit 5 measures the analog signal AS present on the analog bus 4.2 and outputs it again in a time-controlled manner on the analog bus 4.2 so that it can be picked up by the interface functional module 3.4 and routed to the corresponding functional unit 2.4. Thus, according to the ROM table 6, a fixed assignment is provided between the inputs and outputs of the interface functional modules 3.1-3.5 connected through the bus system 4 and the associated functional units 2.1-2.5, which corresponds to a hard wiring—which is adaptable by the content of the ROM table 6 and is thus fundamentally application-specific.

It is noted again that the circuit arrangement shown in FIG. 1 functions without analog-to-digital converters or digital-to-analog converters in the interface functional modules 3.1-3.5, yet such converter devices are normally present in conventional ICs in the absence of an analog bus 4.2, resulting in an increased space requirement for the IC 1 and an increased power consumption.

Moreover, the master control unit 5 provided in accordance with the invention controls the analog and digital signals AS, DS transmitted on the bus system 4 in an application-specific manner according to the ROM table 6, thus relieving the load on the microprocessor 9.

As an alternative to the above-described embodiment of the present invention with fixed wiring according to the assignments contained in the ROM table 6, it is also possible in principal, as already mentioned, to implement the master control unit as a software device, in particular as the data processing unit 9, to which end the IC 1 can contain appropriately designed program code in the memory units 10.1 and/or 10.2.

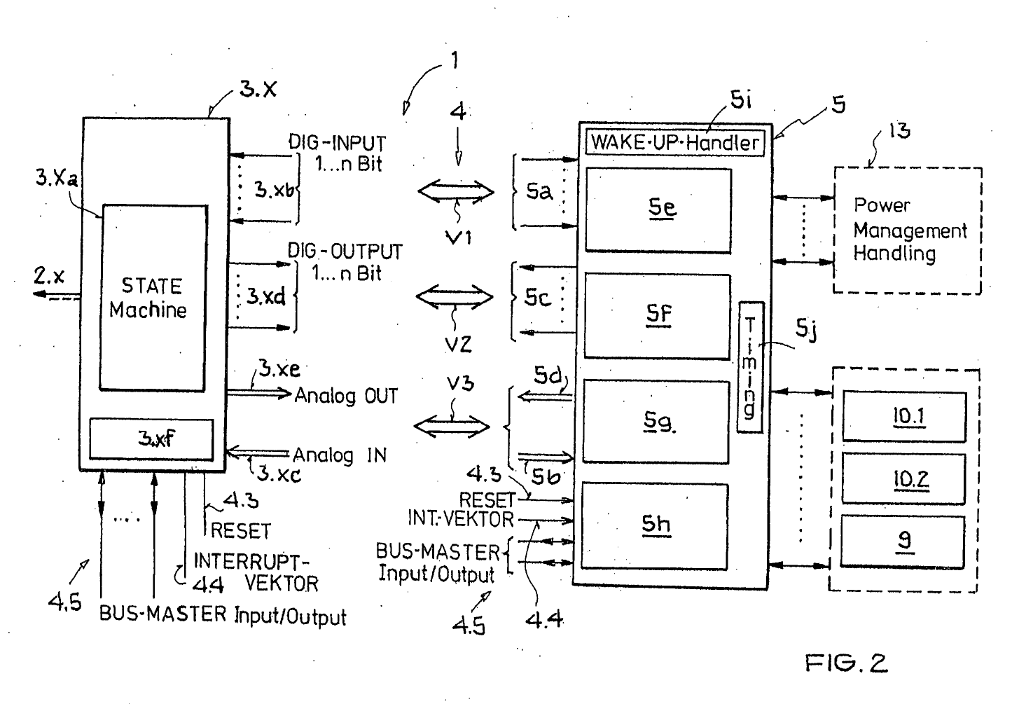

Due to the provision of a combined analog/digital bus system 4 in conjunction with a central signal transmission control by the master control unit 5, the present invention provides—as already mentioned—a fully modular integrated circuit 1, which can be used in practically any way desired, in particular after adaptation of the assignments in the master control unit 5, especially for the automotive applications mentioned above. The functional relationships described above in this context are described again below in greater detail with reference to FIG. 2.

FIG. 2 shows a functional block diagram of the master control unit 5 (FIG. 1) as a component of an inventive integrated circuit 1 (“standard IC”) (see FIG. 1) in its functional interaction with a standardized interface functional module 3.X, preferably an IP module, where the letter “X” in FIG. 2 represents the numbers “1” through “5” in the representation in FIG. 1.

According to the above description of FIG. 1, each interface functional module 3.X functions as a state machine 3.Xa, where specific states or state transitions of the digital inputs 3.Xb or analog inputs 3.Xc of an interface functional module 3.X are assigned to certain actions, which reflect, by means of digital and analog output signals at the corresponding outputs 3.Xd or 3.Xe and with regard to signal forwarding from the associated functional unit 2.X, to the IC 1 or back from the IC 1 to said functional unit. The aforementioned inputs and outputs of the interface functional module 3.X are—as described above in detail—connected in a “hard wired” form by means of the ROM code in the ROM table 6 (FIG. 1) through a corresponding number of drivers with certain bus inputs 5a, 5b or bus outputs 5c, 5d of the standard IC 1 or its master control unit 5, as shown in FIG. 2 by the double “connection” arrows V1-V3.

According to the above description of FIG. 1, the master control unit 5 also functions in accordance with the invention as a state machine 5e with regard to the routing of digital and analog signals DS and AS through the bus system 4 (FIG. 1), which is to say over the digital bus 4.1 or the analog bus 4.2. In this context, certain states or state changes at the bus inputs 5a, 5b are assigned to certain actions, which is to say signal outputs at the bus outputs 5c, 5d, by the ROM table 6.

Corresponding to the additional functions of the master control unit 5 already described in conjunction with FIG. 1, the master control unit additionally has, in its functional representation in FIG. 2, a scheduler 5f for the digital bus 4.1 (FIG. 1), a scheduler 5.g for the analog bus 4.2, and an appropriate protocol handler 5h for the signal transmission protocol employed, which is known per se to those skilled in the art. In addition, the inventive standard IC 1 also contains a wake-up handler 5i, which defines a reaction of the standard IC 1 to wake-up signals transmitted over the bus system 4. Furthermore, the standard IC 1 shown also has a timing unit 5j for precisely timed control of the above-described sequences. Finally, also shown in FIG. 2, both with respect to the interface functional module 3.X and with respect to the standard IC 1 or the master controller 5, are a reset channel 4.3, interrupt vector channel 4.4, and bus master input/output channels 4.5, which are normally present both in the inventive bus system 4 and in prior art bus systems, as is likewise known per se to those skilled in the art. In this context, the interface functional module 3.X also has a power/watchdog control unit 3.Xf, which is also normally known to those skilled in the art.

The power supply for the circuit arrangement described is routed and controlled separately, which is shown symbolically in FIG. 2 at reference number 13 (power management handling).

The special advantages of the present invention consist in a more economical development of IC derivatives based on a standard IC with a bus system for analog and digital signals, consistent interface between all interface functional modules, high redundancy and great expansion capability. In this way, EMC influences, in particular, can be controlled better. Accordingly, the present invention is distinguished by high operating reliability and diagnostic capabilities in testing. Software updates, for example by what is known as flashing, are facilitated considerably in this way and can be accomplished directly through the (air) interface 11 (see FIG. 1) or the LF channel (functional unit 2.1, see FIG. 1), for example. Since programming errors and updates are expected to increase disproportionately in future, leading to correspondingly high service costs, and because of the presence of a wide variety of country-specific versions, the present invention contributes significantly to progress toward a uniform standard in order to thus make available even to an OEM an instrument for efficiently testing individual system components and software. As shown in FIG. 1, this is preferably accomplished through the (air) interface 11 or the connection pins of the IC 1 by means of a suitable test apparatus 12.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A bus system internal to an integrated circuit for establishing signal connections to a plurality of functional units standing in operative connection to the integrated circuit, which generate and/or process digital and/or analog signals, the bus system comprising:
a digital bus; and
an analog bus.

2. The bus system according to claim 1, further comprising a central master control unit for the digital bus and for the analog bus, the control unit being designed for time-controlled delivery of digital signals and/or analog signals to the appropriate functional units.

3. The bus system according to claim 1, further comprising a plurality of interface functional modules, each of which is designed to connect at least one functional unit to the bus system (4).

4. The bus system according to claim 3, wherein the interface functional modules are IP modules.

5. The bus system according to claim 3, wherein the interface functional modules route digital signals received from the applicable functional units on the digital bus, and route analog signals received from the applicable functional units on the analog bus.

6. The bus system according to claim 2, wherein the master control unit stands in connection with at least one memory unit and/or data processing unit.

7. The bus system according to claim 2, wherein the master control unit is a state machine.

8. The bus system according to claim 2, wherein the master control unit is set up in software for signal transmission on the digital bus and on the analog bus.

9. The bus system according to claim 2, wherein the master control unit is set up for signal transmission on the digital bus and on the analog bus according to predefined assignments or in the form of ROM tables.

10. The bus system according to claim 1, further comprising an interface for connecting a test apparatus that is designed for testing at least one of the functional units, interface functional modules, or signal transmission configuration of the master control unit.

11. An Integrated circuit for connecting a number of functional units, comprising the bus system according to claim 1.

12. A circuit arrangement comprising:
an integrated circuit according to claim 11, and
a plurality of functional units connected to the integrated circuit, which generate and/or process digital and/or analog signals.
